(19) United States
(12) Patent Application Publication
(10) Pub. No.: US 2011/0268155 A1
(43) Pub. Date: Nov. 3, 2011

(54) DISTANCE ESTIMATION APPARATUS, SYSTEM AND METHOD USING RANGING COUNTER

(76) Inventors: Mi Kyung Oh, Daejeon (KR); Hong Soon Nam, Daejeon (KR); Jae Young Kim, Daejeon (KR)

(21) Appl. No.: 12/681,008

(22) PCT Filed: Jul. 16, 2008
(86) PCT No.: PCT/KR08/04162

§ 371 Date: Mar. 31, 2010

(30) Foreign Application Priority Data
Oct. 4, 2007 (KR) 10-2007-0099615

(51) Int. Cl. H04B 1/00

(52) U.S. Cl. 375/130; 375/E01.001

(57) ABSTRACT

Provided is a distance estimation apparatus, system and method for accurately estimating the distance between TX/RX devices by means of low-end hardware in a communication system such as the IEEE 802.15.4a system. The distance estimation apparatus includes an analog-to-digital converter, a parallelizer, a parallel synchronization means, a counter, and a system clock generator. The analog-to-digital converter analog-to-digital converts a received packet signal to generate a serial digital signal, and the parallelizer 1:N parallelizes the serial digital signal. The parallel synchronization means includes an N number of buffers for receiving the output of the parallelizer. A counter outputs a count value for estimation of the propagation delay time of a UWB signal on the basis of the sampling data retained in the parallel synchronization means. The system clock generator generates a system clock in the distance estimation apparatus. Therefore, it is possible to accurately estimate the distance between the TX/RX devices by arithmetically calculating a received signal while operating a ranging counter with a low-rate system clock, thereby simplifying the hardware structure and minimizing power consumption.

### TECHNICAL FIELD

The present disclosure relates to distance estimation, and more particularly, to a distance estimation apparatus and method using a ranging counter in a communication system capable of distance estimation like the IEEE 802.15.4a standard.

This work was partly supported by the IT R&D program of MIC/IITA[2007-S-070-02, Development of Cognitive Wireless Home Networking System].

### BACKGROUND ART

Pulse-based UWB wireless technology is attracting much attention as the promising technology because of its low power implementation and inherent distance estimation capabilities. The pulse-based UWB wireless technology was adopted as the physical layer technology of the IEEE 802.15.4a, the international standard of a low-rate location-aware Wireless Personal Area Network (WPAN).

A typical example of a distance estimation technique using UWB pulses is a time-of-arrival (TOA) technique that estimates the distance between two devices by measuring a radio wave propagation time between the two devices.

The TOA technique can estimate the distance between two devices by using a one-way ranging (OWR) technique that exchanges messages between two synchronized devices, or by using a two-way ranging (TWR) technique that exchanges messages between two non-synchronized devices.

A conventional method for performing distance estimation using a TOA technique will be described with reference to FIGS. 1 and 2.

FIG. 1 is a diagram illustrating an OWR technique for performing distance estimation by using UWB signals.

The OWR technique is based on the assumption that a receive (RX) device and a transmit (TX) device are synchronized and also the RX device knows about the time t₁ when the TX device transmitted a UWB pulse 100 to be used as a criterion for distance estimation. Thus, the RX device detects from an RX signal the time t₂, at which a first arrival point 101 exceeding a threshold value is received, to estimate a TOA tₚ corresponding to the difference (t₂t₁) between the TX and RX times of the UWB pulse 100, and multiplies the TOA tₚ by the propagation speed of a radio signal (i.e., the speed of light) to estimate the distance between the TX device and the RX device.

FIG. 2 is a diagram illustrating a method for estimating the distance between two non-synchronized devices by using a TWR technique.

As illustrated in FIG. 2(a), a tₚ 211 corresponding to a TOA in the TWR can be expressed as Equation (1):

$${t}_{p} = \frac{{T}_{roundA} - {T}_{replyB}}{2} \qquad ( 1 )$$

A T_{roundA} 201 and a T_{replyB} 212 are needed to obtain the TOA, which can be obtained through a process illustrated in FIG. 2(b).

In operation S221, a device A 200 starts its counter at the time to transmit a RMARKER of a request packet to be transmitted for distance estimation.

In operation S222, a device B 210 starts its counter at the time to receive the RMARKER of the request packet from the device A 200.

In operation S223, the device B 210 obtains the T_{replyB} 212 by stopping its counter at the time to transmit a RMARKER of a reply packet for the request packet to the device A 200, and transmits the reply packet carrying information about the T_{replyB} 212 to the device A 200.

In operation S224, the device A 200 obtains the T_{roundA} 201 by stopping its counter at the time to receive the RMARKER of the reply packet from the device B 210.

The device A 200 calculates the tₚ 211 by substituting the T_{replyA} 212 of the reply packet received from the device B 210 and the T_{roundA} 201 calculated by the device A 200 into Equation (1). The distance between the device A 200 and the device B 210 can be calculated by multiplying the tₚ 211 by the speed of light.

Herein, the reply packet and the request packet are RFRAME packets used for distance estimation, which are obtained by setting the 10^{th} bit (ranging bit) of a PHY header of a UWB packet to ‘1’. The RMARKER is the first UWB pulse of the first symbol of the PHY header of the RFRAME packet, which is used as a criterion for determining the time to transmit/receive a UWB packet signal between the two TX/RX devices.

In both of the OWR and TWR techniques, each of the devices transmitting/receiving the UWB packet can accurately know the time to transmit the RMARKER. However, the precision of the counter of the RX device must be high in order for the RX device to accurately detect the time to receive the RMARKER contained in the packet received from the TX packet.

In order to perform accurate distance estimation using the TOA technique, the time to receive the RMARKER must be detected with high accuracy. For example, if the RX device detects the location of the peak of the RMARKER in the RX packet inaccurately with an error of 1 nsec, an error of 30 cm occurs in the distance estimation.

The RX time of the RMARKER must be detected as accurately as possible in order to obtain an accurate TOA. Thus, a ranging counter must operate at a high speed (at several GHz or higher) in order to obtain a distance estimation accuracy of about several tens of cm.

However, operating a ranging counter at a high speed in hardware has a limitation in accuracy and also requires a high system clock, making it very difficult to construct a low-price, low-power, low-rate location-aware WPAN system.

In order to accurately estimate the distance between two devices, the TWR technique exchanging messages between two non-synchronized devices requires a high-speed ranging counter, which necessitates a complicated system, a high cost, and high power consumption.

### DISCLOSURE OF INVENTION

### Technical Problem

Therefore, an object of the present invention is to provide a distance estimation apparatus, system and method that can accurately estimate the distance between TX/RX devices by arithmetically calculating a received signal while operating a ranging counter with a low-rate system clock, thereby simplifying the hardware structure and minimizing power consumption.

### Technical Solution

To achieve these and other advantages and in accordance with the purpose(s) of the present invention as embodied and broadly described herein, a distance estimation apparatus using UWB packets an apparatus in accordance with an aspect of the present invention includes: an analog-to-digital converter for analog-to-digital converting a received UWB packet signal to generate a serial digital signal; a parallelizer for 1:N parallelizing the serial digital signal; a parallel synchronization means comprising an N number of buffers for receiving the output of the parallelizer; a counter for outputting a count value for estimation of the propagation delay time of a UWB packet signal on the basis of the data retained in the parallel synchronization means; and a system clock generator for generating a system clock in the distance estimation apparatus.

Herein, the parallelizer may include a 1:N DEMUX and may receive an operation clock from a N times multiplier multiplying the clock of the system clock generator by N, to parallelize an N number of data per the clock frequency of the system clock. Also, the counter may divide an N number of parallel data in the parallel synchronization means with M-time accuracy to obtain the arrival time of the first peak exceeding a predetermined threshold value in the UWB packet signal, and may count the obtained arrival time.

To achieve these and other advantages and in accordance with the purpose(s) of the present invention, a distance estimation system using UWB packets in accordance with another aspect of the present invention includes: any one of the above-described distance estimation apparatuses; and an arrival time estimator for calculating the arrival time of predetermined reference data in the UWB packet signal on the basis of the count value output from the distance estimation apparatus, wherein the distance estimation system estimates the distance between a first device and a second device, which communicate the UWB packets, on the basis of the arrival time of the reference data and the known transmission time of the predetermined reference data.

To achieve these and other advantages and in accordance with the purpose(s) of the present invention, a distance estimation method in accordance with another aspect of the present invention includes: analog-to-digital converting a received UWB packet signal to generate a serial digital signal; 1:N parallelizing the serial digital signal; and detecting the first peak point of a UWB packet signal by performing a data operation on the 1:N parallelized data.

To achieve these and other advantages and in accordance with the purpose(s) of the present invention, a wireless signal peak estimation method in accordance with another aspect of the present invention includes: receiving a wireless signal and analog-to-digital converting the received wireless signal; 1:N parallelizing the analog-to-digital converted data; selecting a peak value and data adjacent to the peak value by simultaneously processing an N number of the parallelized data; and detecting an actual peak point of the wireless signal by performing an arithmetic operation on the selected data.

### Advantageous Effects

The present invention makes it possible to accurately estimate the distance between TX/RX devices by arithmetically calculating a received signal while operating a ranging counter with a low-rate system clock. The present invention can be applied to any distance estimation scheme such as OWR and TWR.

### BRIEF DESCRIPTION OF THE DRAWINGS

FIG. 1 is a diagram illustrating an OWR technique for performing distance estimation using UWB signals.

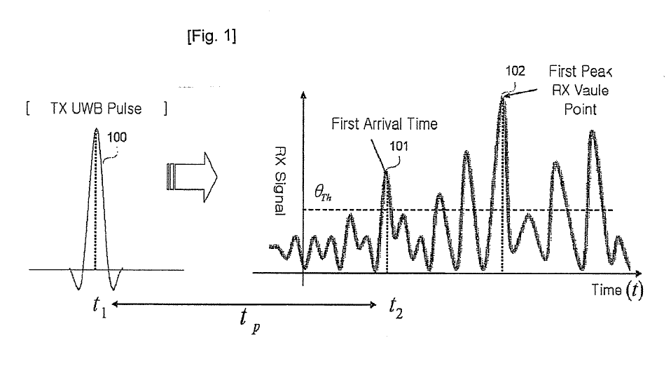

FIG. 2 is a diagram illustrating a TWR technique for performing distance estimation using UWB signals.

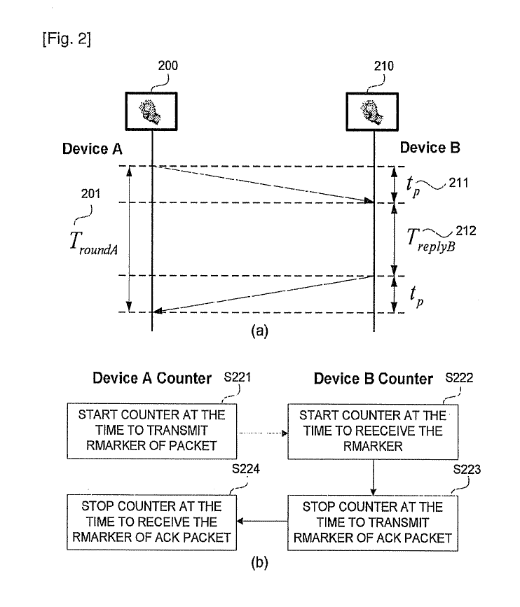

FIG. 3 is a diagram illustrating an exemplary format of an IEEE 802.15.4a UWB packet.

FIG. 4 is a diagram illustrating a channel profile obtained by correlating an RX signal and a ternary code of a UWB packet.

FIG. 5 is a block diagram of a distance estimation apparatus according to the present invention.

FIG. 6 is a diagram illustrating the precision of each unit of the distance estimation apparatus illustrated in FIG. 5.

FIG. 7 is a diagram illustrating a method for increasing accuracy in distance estimation by performing an arithmetic operation in the distance estimation apparatus according to the present invention.

### BEST MODE FOR CARRYING OUT THE INVENTION

Hereinafter, specific embodiments will be described in detail with reference to the accompanying drawings.

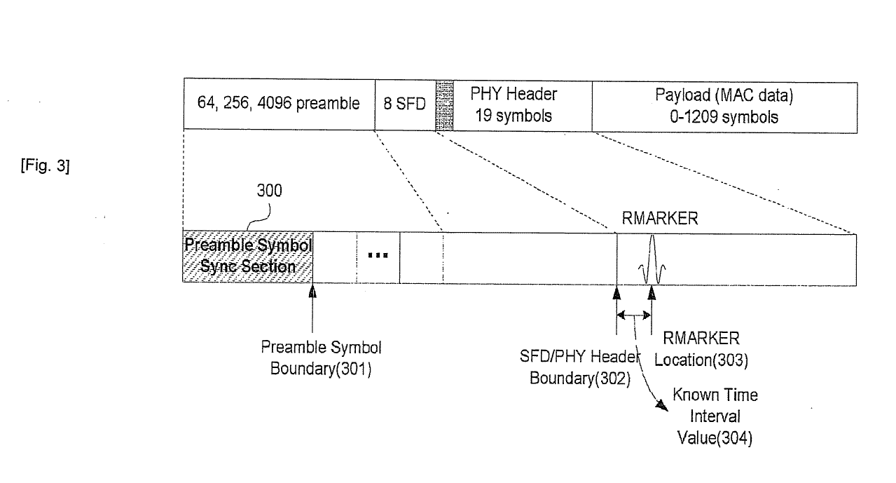

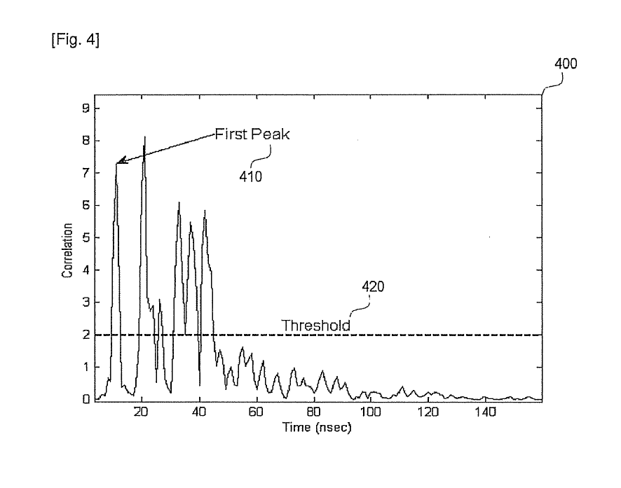

FIG. 3 is a diagram illustrating an exemplary format of an IEEE 802.15.4a UWB packet. FIG. 4 is a diagram illustrating a channel profile obtained by correlating an RX signal and a ternary code of a UWB packet, based on a channel model proposed by the IEEE 802.15.4a Task Group, that is, CM1 (Residential LOS environments).

Referring to FIG. 3, a UWB packet consists of 64-symbols (or 256-symbols or 4096-symbols) ternary code preamble 300, an 8-symbol Start Frame Delimiter (SFD), a 19-symbol s physical layer (PHY) header, and payload data.

When the 10^{th} bit (ranging bit) of the PHY header is set to ‘1’, the UWB packet is called a RFRAME, which is used to estimate the distance between TX/RX devices. The first UWB pulse of the first symbol of the PHY header of the RFRAME is called a RMARKER 303, which is used as a standard location in the IEEE 802.15.4a UWB RFRAME packet for obtaining a TOA.

The RX device performs a preamble symbol sync process through a preamble section that is foreknown by both of the TX/RX devices. The RX device performs the preamble symbol sync process to detect a preamble symbol boundary 301, because it cannot know the start of a ternary-code preamble symbol when receiving a packet.

An SFD symbol is received after a predetermined time (=the number of remaining preambles*1 preamble symbol duration) from the preamble symbol boundary 301. When all the 8 SFD symbols are received, a signal indicating the start of the PHY header is generated. The RMARKER 303 is received after a known time 304 from a SFD/PHY header boundary 302.

Thus, the SFD/PHY header boundary 302 must be detected in order to operate a ranging counter by accurately detecting the start of the RMARKER 303. The SFD/PHY header boundary 302 is determined by the preamble symbol boundary 301. The preamble symbol boundary 301 corresponds to a first peak 410 exceeding a predetermined threshold 420 in FIG. 4 that illustrates a channel profile obtained by correlating an RX signal and a ternary code of a UWB packet. Therefore, the first peak 410 of FIG. 4 must be accurately detected for accurate distance estimation.

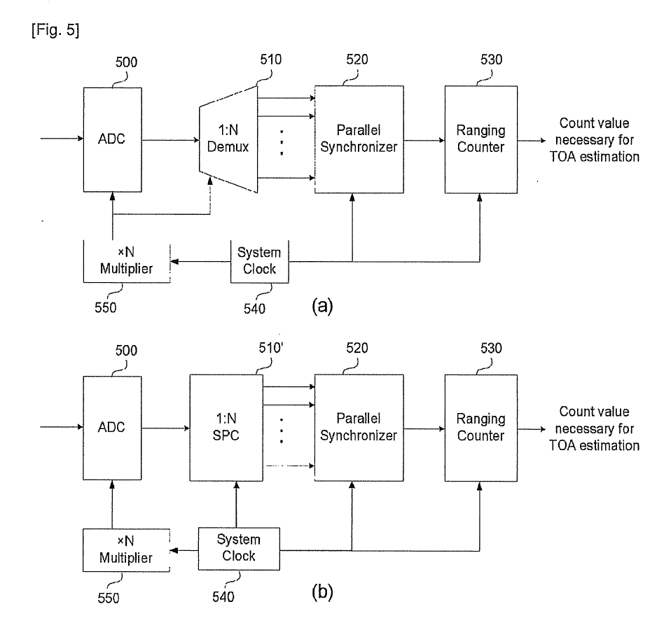

In an embodiment of the present invention, the first peak 410 of FIG. 4 is detected through the following three steps, which will be described in detail with reference to FIGS. 5 through 7.

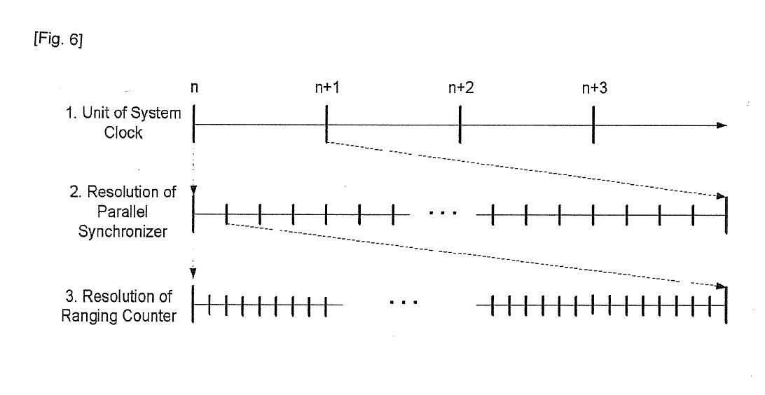

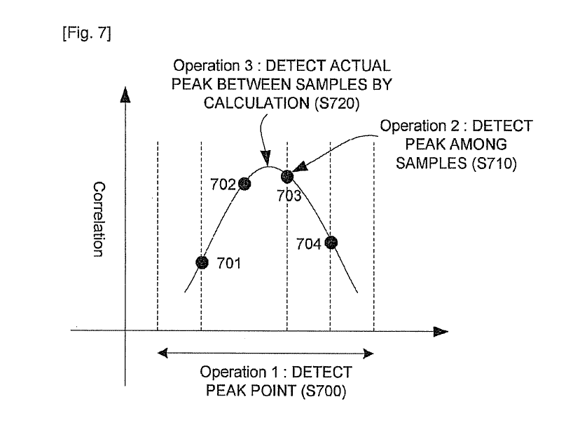

FIG. 5 illustrates two embodiments of a distance estimation apparatus including a ranging counter that can provide high accuracy while operating with a low-rate system clock according to the present invention. FIG. 6 is a diagram illustrating the precision of each unit of the distance estimation apparatus illustrated in FIG. 5. FIG. 7 is a diagram illustrating a method for increasing accuracy in distance estimation by performing an arithmetic operation in the distance estimation apparatus according to the present invention.

Referring to FIG. 5, a distance estimation apparatus according to the present invention includes: an analog-to-digital converter (ADC) 500 for sampling an RX signal to generate a digital signal; a parallelizer 510/510′ for 1:N dividing the digital signal output from the ADC 500, a parallel synchronizer 520 for parallel-processing the divided signals output from the parallelizer 510/510′; a ranging counter 530 for outputting a count value for TOA estimation on the basis of the output signals from the parallel synchronizer 520; a low-rate system clock 540; and a multiplier 550.

The parallelizer may be a 1:N DEMUX 510 (See FIG. 5(a)) or a 1:N serial-to-parallel converter (SPC) 510′(See FIG. 5(b)), to which the present invention is not limited. That is, the parallelize may be any device that can 1:N parallelize the output signal of the ADC 500.

The distance estimation apparatus illustrated in FIG. 5 operates with a clock signal from the low-rate system clock 540, thereby enabling low cost and low power consumption using relatively low-end hardware.

In order to analog-to-digital convert a high-rate RX UWB signal, the ADC 500 performs analog-to-digital conversion in accordance with the output of the multiplier 550 that multiplies a system clock signal by N. The data output from the ADC 500 are parallelized by the 1:N parallelizer 510/510′, and the resulting parallel data are provided to the parallel synchronizer 520.

The parallel synchronizer 520 operates in accordance with a low-rate system clock 540 (See a reference numeral 1 in FIG. 6). However, the 1:N parallelized data are maintained by the 1:N parallelizer 510 and the data are parallel-processed simultaneously, thereby obtaining data adjacent to the first peak 410 (See FIG. 4) with the same accuracy (or resolution) as the ADC 500 (See a reference numeral 1 in FIG. 6). That is, N-time more data can be processed than the rate of the low-rate system clock 540.

The parallel synchronizer 520 parallel-processes the maintained parallel data and selects a peak 703 and its adjacent data 701, 702 and 704 as illustrated in FIG. 7 (S710).

Thereafter, the ranging counter 530 estimates an actual peak by performing an M-time sub-sampling operation on the data maintained in the parallel synchronizer 520 (S720). Herein, the actual peak may be estimated using a numerical analysis scheme such as interpolation.

In this way, it is possible to obtain the accuracy N×M times higher than the accuracy of a low-rate counter.

After estimating the actual peak, the ranging counter 530 counts the arrival time of the actual peak or the arrival time of an RMARKER received after a predetermined time interval, to output the resulting count value. A TOA is obtained on the basis of the resulting count value to estimate the distance.

In the above-described embodiment, the parallel synchronizer 520 detects the peak with an N-time accuracy (S710) and the ranging counter 530 gives an M-time accuracy thereto (S720). In another embodiment, the parallel synchronizer 520 may just maintain the parallelized data and the ranging counter 530 may perform both of the operations 710 and 720.

Also, because the desired accuracy in the distance estimation differs depending on various application types, the distance estimation apparatus or system may be configured to have a variable accuracy. The distance estimation apparatus according to the present invention can easily provide various accuracies for various types of distance estimations by adjusting the parallelization degree N and the numerical analysis interval M.

Also, the above-described distance estimation apparatus may be included in the TX/RX devices communicating UWB packets or may be included in a third device in order to implement a distance estimation system that can estimate the distance between the UWB TX/RX devices with high accuracy.

Also, because the essential matter of the technical concept of the present invention is to provide an apparatus and method for detecting the arrival time of a wireless signal with high accuracy while using a low-rate system clock, the present invention can be applied not only to distance estimation but also to general wireless communication.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

1. A distance estimation apparatus using ultra-wideband(UWB) packet signal, the distance estimation apparatus comprising:
an analog-to-digital converter for analog-to-digital converting a received UWB packet signal to generate a serial digital signal;
a parallelizer for 1:N parallelizing the serial digital signal;
a parallel synchronization means comprising an N number of buffers for receiving the output of the parallelizer;
a counter for outputting a count value for estimation of the propagation delay time of an UWB packet signal on the basis of the data retained in the parallel synchronization means; and
a system clock generator for generates a system clock in the distance estimation apparatus.

2. The apparatus of claim 1, wherein the parallelizer comprises a 1:N DEMUX and receives an operation clock from a multiplier multiplying the clock of the system clock generator by N, to parallelize an N number of data per the clock frequency of the system clock.

3. The apparatus of claim 1, wherein the parallelizer comprises a 1:N serial-to-parallel converter and provides an N number of data to the parallel synchronization means in synchronization with the system clock from the system clock generator.

4. The apparatus of claim 1, wherein the counter divides an N number of parallel data in the parallel synchronization means with M-time accuracy to obtain the arrival time of the first peak exceeding a predetermined threshold value in the UWB packet signal, and counting the obtained arrival time.

5. The apparatus of claim 4, wherein
the parallel synchronization means extracts a plurality of data adjacent to the first peak of the UWB packet signal among an N number of the data; and
the counter performs a data operation on a plurality of the data to divide the interval between the data into an M number of subintervals to estimate the first peak of the UWB packet signal with an accuracy N×M times higher than the system clock frequency.

6. The apparatus of claim 5, wherein the data operation is performed using a numerical analysis scheme including interpolation.

7. A distance estimation system using ultra-wideband(UWB) packets, the distance estimation system comprising:
the distance estimation apparatus of claim 1; and
an arrival time estimator for calculating the arrival time of predetermined reference data in the UWB packet signal on the basis of the count value output from the distance estimation apparatus,
wherein the distance estimation system estimates the distance between a first device and a second device, which communicate the UWB packets, on the basis of the arrival time of the reference data and the known transmission time of the predetermined reference data.

8. The distance estimation system of claim 7, wherein
the second device obtains a replay time by calculating the difference between the arrival time of predetermined reference data of a request packet received from the first device and the transmission time of predetermined reference data of a replay packet transmitted from the second device, and transmits the replay packet containing the obtained replay time information to the first device; and
the first device obtains a round-trip time by calculating the difference between the transmission time of the reference data of the request packet and the arrival time of the reference data of the replay packet received from the second device, calculates the propagation time of the UWB packet between the first device and the second device on the basis of the obtained round-trip time, and estimates the distance between the first device and the second device by multiplying the calculated propagation time by the speed of light.

9. The distance estimation system of claim 7, wherein
the first device transmits a request packet containing the transmission time of the reference data to the second device; and
the second device calculates the arrival time of the reference data of the request packet by means of the arrival time estimator, and estimates the distance between the first device and the second device by multiplying the difference between the transmission/arrival times of the reference data by the speed of light.

10. A distance estimation method comprising:
analog-to-digital converting a received ultra-wideband(UWB) packet signal to generate a serial digital signal;
1:N parallelizing the serial digital signal; and
detecting the first peak point of an UWB packet signal by performing a data operation on the 1:N parallelized data.

11. The distance estimation method of claim 10, wherein the detecting of the first peak point comprises estimating the first peak point with an accuracy of M times with respect to the 1:N parallelized data by using an arithmetic analysis scheme including interpolation.

12. The distance estimation method of claim 11, wherein the detecting of the first peak point comprises estimating the first peak point with an accuracy N×M times higher than the low-rate system clock of an wireless transmitting/receiving device.

13. The distance estimation method of claim 10, further comprising:
estimating the arrival time and point of predetermined reference data of the UWB packet signal on the basis of the first peak point; and
estimating the distance between the UWB packet transmitting/receiving devices on the basis of the estimated arrival time of the reference data.

14. A wireless signal peak estimation method comprising:
receiving a wireless signal and analog-to-digital converting the received wireless signal;
1:N parallelizing the analog-to-digital converted data;
selecting a peak value and data adjacent to the peak value by simultaneously processing an N number of the parallelized data; and
detecting an actual peak point of the wireless signal by performing an arithmetic operation on the selected data.
